(19) United States
(12) Patent Application Publication
(10) Pub. No.: US 2023/0177442 A1
(43) Pub. Date: Jun. 8, 2023

(54) PROCESS FRAMEWORK FOR PRODUCTION FACILITY QUALIFICATION

(71) Applicant: SAP SE, Waldorf (DE)

(72) Inventors: Balachandar Ponnusamy, Bangalore (IN); Chandrasekhar Ajjarapu, Bangalore (IN); Prashant Bhagat, San Jose, CA (US); Lakshmi Kanta Nandi, Bangalore (IN)

(21) Appl. No.: 17/542,335

(22) Filed: Dec. 3, 2021

(51) Int. Cl. G06Q 10/06; G06Q 50/04

(52) U.S. Cl. CPC G06Q 10/06395; G06Q 50/04

(57) ABSTRACT

A method may include receiving, from a first client device, a first user input specifying one or more attributes of a production facility. One or more modular questionnaires corresponding to the attributes of the production facility may be identified. A second user input responsive to the one or more modular questionnaires may be received from the first client device and/or a second client device. The second user input may include data associated with the production facility. The production facility may be qualified based on at least a portion of the data. While the data remains unexpired, the data collected via the modular questionnaire may be reused to qualify the same production facility for a different commodity and/or a different production facility of the same supplier. Upon expiration of the data or another trigger, the production facility may be requalified based on additional data associated with the production facility.

### TECHNICAL FIELD

The subject matter described herein relates generally to data processing and more specifically to a framework for creating custom lifecycle management processes for production facility qualification.

### BACKGROUND

An enterprise may rely on a suite of enterprise software applications for sourcing, procurement, supply chain management, invoicing, and payment. These enterprise software applications may provide a variety of data processing functionalities including, for example, billing, invoicing, procurement, payroll, time and attendance management, recruiting and onboarding, learning and development, performance and compensation, workforce planning, and/or the like. Data associated with multiple enterprise software applications may be stored in a common database in order to enable a seamless integration between different enterprise software applications. For example, an enterprise resource planning (ERP) application may track resources, such as cash, raw materials, and production capacity, and the status of various commitments such as purchase order and payroll. In the event the enterprise interacts with large and evolving roster of external vendors, the enterprise resource planning (ERP) application may be integrated with a supplier lifecycle and performance management (SLP) application configured to perform one or more of supplier identification, selection and segmentation, onboarding, performance management, information management, risk management, relationship management, and offboarding.

### SUMMARY

Systems, methods, and articles of manufacture, including computer program products, are provided for creating one or more custom lifecycle processes for production facility qualification. In some example embodiments, there is provided a system that includes at least one processor and at least one memory. The at least one memory may include program code that provides operations when executed by the at least one processor. The operations may include: receiving, from a first client device, a first user input specifying one or more attributes of a first production facility; identifying a first modular questionnaire corresponding to the one or more attributes of the first production facility; receiving, at the first client device and/or a second client device, a second user input responsive to the first modular questionnaire, the second user input including a first data associated with the first production facility; and qualifying, based on at least a portion of the first data, the first production facility.

In some variations, one or more features disclosed herein including the following features can optionally be included in any feasible combination. The first user input may further define an expiration schedule associated with the first production facility.

In some variations, the operations may further include: reusing, while the first data remains unexpired based on the expiration schedule, at least a portion of the first data to qualify the first production for a different matrix dimension and/or a second production facility associated with a same supplier, the different matrix dimension comprising one or more of a different commodity, a different region, a different department, or a custom process type.

In some variations, the operations may further include: determining, based at least on the expiration schedule, an expiration of the first data associated with the first production facility; and in response to determining the expiration of the first data, requalifying the first production facility by at least a third user input received from the first client device and/or the second client device, the third user input comprising a second data responsive to the first modular questionnaire.

In some variations, the first user input may further define a reminder schedule associated with the first production facility.

In some variations, the operations may further include: generating, based at least on a time and/or a frequency specified by the reminder schedule, a reminder to requalify the first production facility.

In some variations, the operations may further include: identifying a second modular questionnaire corresponding to the one or more attributes of the first production facility; and receiving, from the first client device and/or the second client device, a third user input responsive to the second modular questionnaire, the third user input including a second data associated with the first production facility.

In some variations, the operations may further include: in response to a failure to qualify the first production facility based on the first data collected via the first modular questionnaire and/or the second data collected via the second modular questionnaire, qualifying the first production facility based on a fourth user input received from the first client device and/or the second client device.

In some variations, the operations may further include: in response to failing to identify a modular questionnaire corresponding to the one or more attributes of the first production facility, generating an error message for display at the first client device and/or the second client device.

In some variations, the first modular questionnaire may include a mandatory questionnaire or an optional questionnaire.

In some variations, the first modular questionnaire may include an electronic form that is displayed at the first client device and/or the second client device.

In some variations, the qualification of the first production facility may be performed via an application programming interface (API).

In some variations, the first data and/or an outcome of the qualification may be shared with a third party system in an extensible markup language (XML) format.

In another aspect, there is provided a method for creating one or more custom lifecycle processes for production facility qualification. The method may include: receiving, from a first client device, a first user input specifying one or more attributes of a first production facility; identifying a first modular questionnaire corresponding to the one or more attributes of the first production facility; receiving, at the first client device and/or a second client device, a second user input responsive to the first modular questionnaire, the second user input including a first data associated with the first production facility; and qualifying, based on at least a portion of the first data, the first production facility.

In some variations, one or more features disclosed herein including the following features can optionally be included in any feasible combination. The first user input may further define an expiration schedule associated with the first production facility. While the first data remains unexpired based on the expiration schedule, at least a portion of the first data may be reused to qualify the first production for a different matrix dimension and/or a second production facility associated with a same supplier. The different matrix dimension may include one or more of a different commodity, a different region, a different department, or a custom process type.

In some variations, the method may further include: identifying a second modular questionnaire corresponding to the one or more attributes of the first production facility; and receiving, from the first client device and/or the second client device, a third user input responsive to the second modular questionnaire, the third user input including a second data associated with the first production facility.

In some variations, the method may further include: in response to a failure to qualify the first production facility based on the first data collected via the first modular questionnaire and/or the second data collected via the second modular questionnaire, qualifying the first production facility based on a fourth user input received from the first client device and/or the second client device.

In some variations, the first modular questionnaire may include a mandatory questionnaire or an optional questionnaire.

In some variations, the first modular questionnaire may include an electronic form that is displayed at the first client device and/or the second client device.

In another aspect, there is provided a computer program product including a non-transitory computer readable medium storing instructions. The instructions may cause operations may executed by at least one data processor. The operations may include: receiving, from a first client device, a first user input specifying one or more attributes of a first production facility; identifying a first modular questionnaire corresponding to the one or more attributes of the first production facility; receiving, at the first client device and/or a second client device, a second user input responsive to the first modular questionnaire, the second user input including a first data associated with the first production facility; and qualifying, based on at least a portion of the first data, the first production facility.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes, it should be readily understood that such features are not intended to be limiting. The claims that follow this disclosure are intended to define the scope of the protected subject matter.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a system diagram illustrating an example of a supplier lifecycle management system, in accordance with some example embodiments;

FIG. 2A depicts a schematic diagram illustrating an example of a framework for creating custom lifecycle management process for production facility qualification, in accordance with some example embodiments;

FIG. 2B depicts a user interface displaying an example of an electronic intake form, in accordance with some example embodiments;

FIG. 3A depicts a flowchart illustrating an example of a process for a customized lifecycle management process for production facility qualification, in accordance with some example embodiments;

FIG. 3B depicts a flowchart illustrating another example of a process for a customized lifecycle management process for production facility qualification, in accordance with some example embodiments;

FIG. 4 depicts a flowchart illustrating an example of a process for a customized lifecycle management process for production facility qualification, in accordance with some example embodiments;

FIG. 5 depicts a block diagram illustrating an example of a computing system, in accordance with some example embodiments; and

When practical, similar reference numbers denote similar structures, features, or elements.

### DETAILED DESCRIPTION

Enterprise software applications may provide a variety of procurement and supply chain management solutions including enterprise resource planning (ERP) and supplier lifecycle and performance management (SLP). For example, as noted, a supplier lifecycle and performance management (SLP) application may perform one or more of supplier identification, selection and segmentation, onboarding, performance management, information management, risk management, relationship management, and offboarding. However, a conventional supplier lifecycle and performance management (SLP) application may support a fixed set of lifecycle management processes such as request, registration, qualification, and preferred supplier designation. A typical enterprise, by contrast, may be required to implement different lifecycle management processes for different suppliers. For instance, the enterprise may be required to implement a first lifecycle management process for qualifying a first production facility of a first supplier that is different than a second lifecycle management process for qualifying a second production facility of a second supplier.

As such, in some example embodiments, a lifecycle management controller may be configured to support the creation of custom lifecycle management processes based on one or more modular questionnaire templates. A custom lifecycle management process may include at least one of modular questionnaire configured to collect data for qualifying a production facility (e.g., a factory, a plant, a workshop, a warehouse, a supplier site, and/or the like) of a supplier. Moreover, at least a portion of the data collected via the modular questionnaire may be reused in order to qualify the same production facility for a different matrix dimension (e.g., commodity, region, department, and/or the like) and/or a different production facility of the same supplier. For example, the data collected via the modular questionnaire may be associated with an expiration schedule such as a date and/or an event triggering the expiration of the data. While the data collected via the modular questionnaire remains unexpired, the lifecycle management controller may reuse at least a portion of the data collected via the modular questionnaire to qualify the same production facility for a different matrix dimension (e.g., commodity, region, department, and/or the like) and/or a different production facility of the same supplier. Upon expiration of the data collected via the modular questionnaire, the lifecycle management controller may requalify the production facility by at least deploying the same modular questionnaire to collect data associated with the production facility.

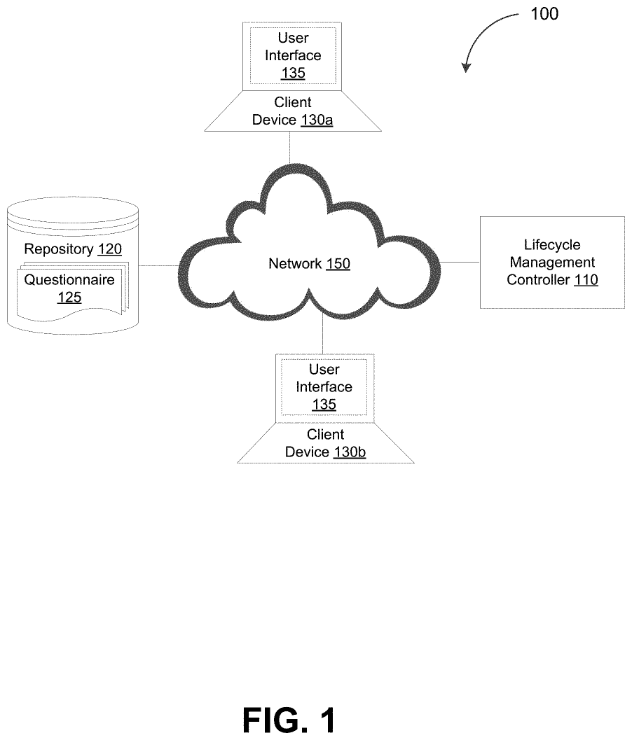

FIG. 1 depicts a system diagram illustrating an example of a procurement system 100, in accordance with some example embodiments. Referring to FIG. 1, the procurement system 100 may include a lifecycle management controller 110, a repository 120, and one or more client devices 130 such as a first client device 130a, a second client device 130b, and a third client device 130c. The lifecycle management controller 110, the repository 120, and the one or more client devices 130 may be communicatively coupled via a network 140. The one or more client devices 130 may include processor-based devices including, for example, a smartphone, a tablet computer, a wearable apparatus, a virtual assistant, an Internet-of-Things (IoT) appliance, and/or the like. The repository 120 may be a database including, for example, a relational database, a non-structured query language (NoSQL) database, an in-memory database, a graph database, a key-value store, a document store, and/or the like. The network 140 may be any wired network and/or a wireless network including, for example, a wide area network (WAN), a local area network (LAN), a virtual local area network (VLAN), a public land mobile network (PLMN), the Internet, and/or the like.

In some example embodiments, the lifecycle management controller 110 may support the creation of a custom lifecycle management process based on one or more modular questionnaire templates. For example, the custom lifecycle management process may include one or more modular questionnaires configured to collect data associated with a production facility of a supplier including, for example, a factory, a plant, a workshop, a warehouse, a supplier site, and/or the like. Moreover, the lifecycle management controller 110 may qualify, based at least on the data collected via the one or more modular questionnaires, the production facility.

In some example embodiments, the lifecycle management controller 110 may select, based on one or more user inputs, a modular questionnaire 125 from the repository 120 for inclusion in the custom lifecycle management process. Alternatively and/or additionally, the modular questionnaire 125 included in the custom lifecycle management process may be selected by the lifecycle management controller 110 based on the category of the production facility including, for example, a direct production facility, an indirect production facility, a warehouse, and/or the like. The modular questionnaire 125 selected for inclusion in the custom lifecycle management process may also be identified by the lifecycle management controller 110 based on the commodity, region, and/or department associated with the production facility. It should be appreciated that the lifecycle management controller 110 may select a bundle of modular questionnaires for inclusion in the custom lifecycle management process including one or more mandatory questionnaires and/or optional questionnaires.

The lifecycle management controller 110 may, as noted, qualify the production facility based on at least a portion of the data collected via the modular questionnaire 125. In some example embodiments, the lifecycle management controller 110 may reuse at least a portion of the data collected via the modular questionnaire 125 to qualify the same production facility for a different matrix dimension (e.g., commodity, region, department, and/or the like) and/or a different production facility of the same supplier. The reuse of the data collected via the modular questionnaire 125 may be contingent upon an expiration schedule associated with the modular questionnaire 125. For example, as a part of configuring the custom lifecycle management process, the modular questionnaire 125 selected for inclusion in the custom lifecycle management process may be associated with an expiration schedule defining a date and/or an event triggering the expiration of the corresponding data.

As such, while the data collected via the modular questionnaire 125 remains unexpired, the lifecycle management controller 110 may reuse at least a portion of the data collected via the modular questionnaire 125 to qualify the same production facility for a different matrix dimension (e.g., commodity, region, department, and/or the like) and/or a different production facility of the same supplier. Upon expiration of the data collected via the modular questionnaire 125, the lifecycle management controller 110 may requalify the production facility by at least deploying the same modular questionnaires 125 to collect data associated with the production facility. In some example embodiments, the lifecycle management controller 110 may be configured to generate, based at least on a reminder schedule, one or more corresponding reminders. For instance, upon expiration of the data collected via the modular questionnaire 125, the lifecycle management controller 110 may generate one or more reminders to requalify the corresponding production facility. Alternatively and/or additionally, the lifecycle management controller 110 may generate one or more reminders to requalify the production facility at a time and/or frequency ahead of the expiration of the data collected via the modular questionnaire 125.

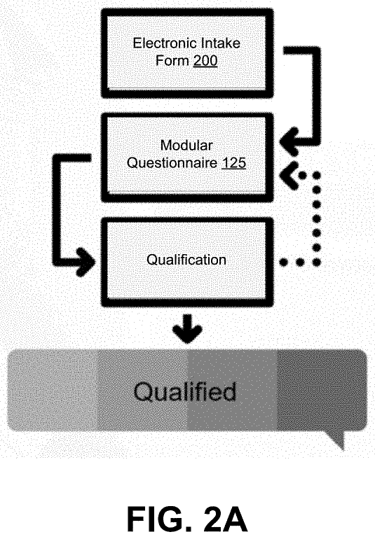

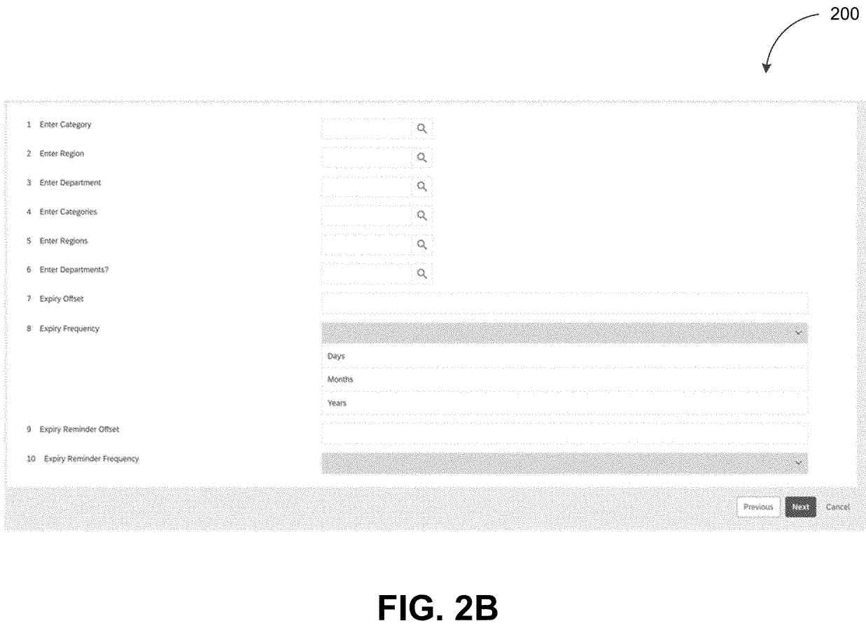

FIG. 2A depicts a schematic diagram illustrating an example of a customized lifecycle management process for production facility qualification, in accordance with some example embodiments. Referring to FIG. 2A, the lifecycle management controller 110 may receive, for example, from the first client device 130a, one or more user inputs specifying a type of production facility (e.g., direct, indirect, warehouse, and/or the like), a commodity associated the production facility, a region associated with the production facility, and/or a department associated with the production facility. The one or more user inputs may be received via an electronic intake form 200 displayed, for example, in a user interface 135 at the first client device 130a. FIG. 2B depicts an example of the electronic intake form 200, which may include input fields for receiving one or more user inputs specifying one or more categories, regions, and departments for a production facility. Furthermore, as shown in FIG. 2B, the electronic intake form 200 may include input fields for receiving one or more user inputs for specifying an expiration schedule (e.g., an expiry offset, an expiry frequency, and/or the like) and a reminder schedule (e.g., an expiry reminder offset, an expiry reminder frequency, and/or the like).

Referring again to FIG. 2A, the lifecycle management controller 110 may select, based at least on the one or more user inputs received via the electronic intake form 200, the modular questionnaire 125 from the repository 120. As noted, the modular questionnaire 125 may be selected based on the type of production facility (e.g., direct, indirect, warehouse, and/or the like), the commodity associated the production facility, the region associated with the production facility, and/or the department associated with the production facility. The modular questionnaire 125 may be configured to collect data associated with the production facility. For example, the modular questionnaire 125 may be sent to the second client device 130b associated with the production facility and/or the supplier associated with the production facility. Moreover, the lifecycle management controller 110 may receive, from the second client device 130b, data provided based at least on the modular questionnaire 125.

As shown in FIG. 2A, the production facility may be qualified based at least on the data collected via the modular questionnaire 125. As used herein, the production facility being qualified may refer to the production facility being designated as suitable for providing a certain commodity. Moreover, as shown in FIG. 2A, the production facility may be requalified upon expiration of the data collected via the modular questionnaire 125. For example, as shown in FIG. 2B, as a part of configuring the custom lifecycle management process, the modular questionnaire 125 selected for inclusion in the custom lifecycle management process may be associated with an expiration schedule (e.g., an expiry offset, an expiry frequency, and/or the like). Accordingly, the lifecycle management controller 110 may determine, based at least on the expiration schedule, when a first data collected via the modular questionnaire 125 expires. The production facility may be qualified based on the first data collected via the modular questionnaire 125. As such, upon the expiration of the first data collected via the modular questionnaire 125, the lifecycle management controller 110 may requalify the production facility by at least sending, to the second client device 130b, the modular questionnaire 125 to collect a second data for requalifying the production facility.

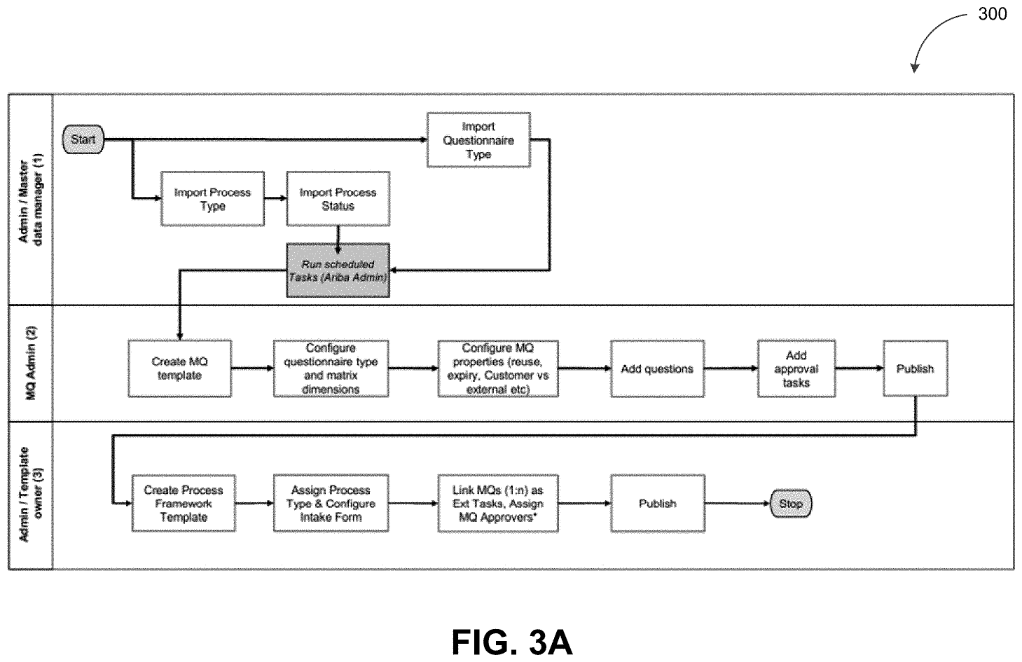

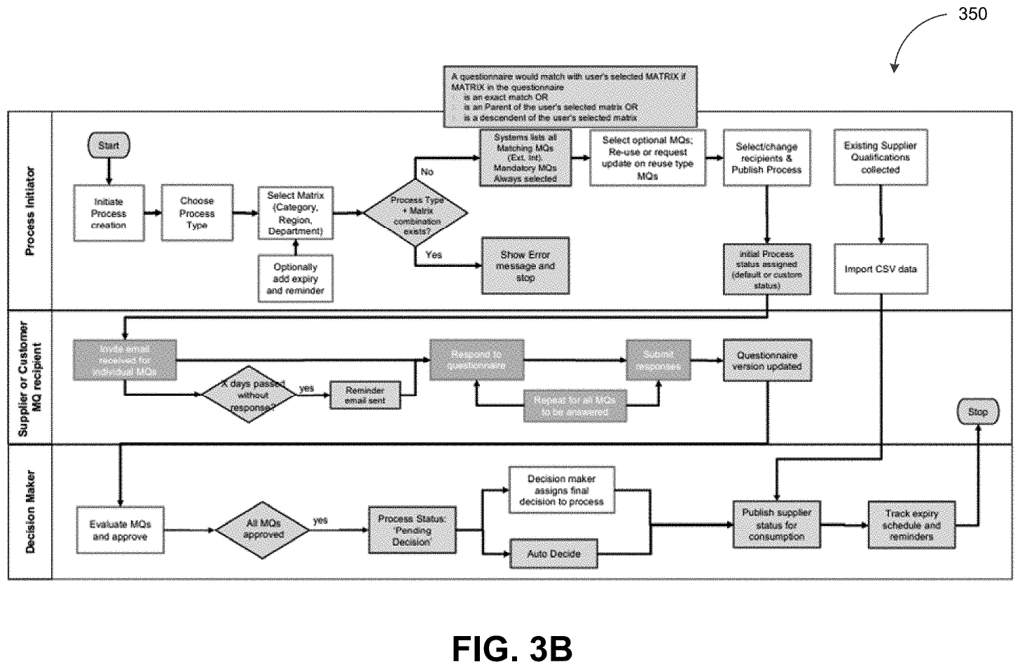

FIG. 3A depicts a flowchart illustrating an example of a process 300 for a customized lifecycle management process for production facility qualification, in accordance with some example embodiments. Referring to FIG. 3A, the process 300 may be performed in order to generate, for example, the modular questionnaire 125. As shown in FIG. 3A, a modular questionnaire template corresponding to the modular questionnaire 125 may be created based on the type of modular questionnaire and the type of lifecycle management process associated with the modular questionnaire. Moreover, the modular questionnaire 125 may be configured based on the corresponding modular question template. For example, as shown in FIG. 3A, the configurations may include specifying a questionnaire type, matrix dimensions, and various modular questionnaire properties (e.g., reuse, expiration, customer or external, and/or the like). The configurations may further include the addition of one or more questions to the modular question template corresponding to the modular questionnaire 125. Upon the insertion of one or more approval tasks, the modular questionnaire 125 may be published, for example, for inclusion in a custom lifecycle management process such as a custom lifecycle management process for qualifying a production facility. For instance, as shown in FIG. 3A, the modular questionnaire 125 may be associated with a process framework template and a corresponding electronic intake form (such as the electronic intake form 200) may be configured. Once the modular questionnaire 125 (and other related modular questionnaires) are linked as external tasks and assigned approvers, the modular questionnaire 125 may be published.

FIG. 3B depicts a flowchart illustrating another example of a process 350 for a customized lifecycle management process for production facility qualification, in accordance with some example embodiments. Referring to FIG. 3B, the process 350 may be performed to implement a customized lifecycle management process to qualify a production facility. For example, as shown in FIG. 3B, the lifecycle management controller 110 may receive, from the first client device 130a, one or more user inputs to initiate the creation of the custom lifecycle management process. The one or more user inputs, which may be provided via the electronic intake form 200, may specify one or more categories, regions, and departments for the production facility. Moreover, the one or more user inputs may specify an expiration schedule (e.g., an expiry offset, an expiry frequency, and/or the like) and a reminder schedule (e.g., an expiry reminder offset, an expiry reminder frequency, and/or the like).

Referring again to FIG. 3B, the lifecycle management controller 110 may identify, based at least on the one or more user inputs received from the first client device 130a, one or more modular questionnaires for qualifying the production facility such as the modular questionnaire 125. As shown in FIG. 3B, the lifecycle management controller 110 may identify, for inclusion in the customized lifecycle management process, one or more mandatory questionnaires and/or optional questionnaires. In the event the lifecycle management controller 110 is unable to identify a modular questionnaire matching the one or more use inputs received from the first client device 130a, the lifecycle management controller 110 may generate, for display in the user interface 135 at the first client device 130a, an error message.

In some example embodiments, upon identifying the modular questionnaire 125 for inclusion in the custom lifecycle management process, the lifecycle management controller 110 may send, to the second client device 130b associated with the production facility and/or the supplier associated with the production facility, the modular questionnaire 125 to collect data associated with the production facility. In some instances, the modular questionnaire 125 may be an electronic form, in which case at least a portion of the modular questionnaire 125 may be displayed in the user interface 135 at the second client device 130b and the data associated with the production facility may be provided as one or more user inputs received via the modular questionnaire 125 displayed in the user interface 135.

Referring again to FIG. 3B, the lifecycle management controller 110 may receive, from the second client device 130b, data associated with the production facility. Moreover, the lifecycle management controller 110 may qualify, based at least on the data collected via the modular questionnaire 125, the production facility. As shown in FIG. 3B, the production facility may be associated with multiple modular questionnaires, in which case the qualification of the production facility may be contingent upon the approval of each modular questionnaire. Upon being qualified, the status of the production facility may be published, for example, by being displayed at the user interface 135 at the first client device 130a. Moreover, FIG. 3B shows that upon qualifying the production facility, the lifecycle management controller 110 may track when the data collected via the modular questionnaire 125 expires, at which point the lifecycle management controller 110 may requalify the production facility, for example, by sending the modular questionnaire 125 to the second client device 120b to collect additional data associated with the production facility.

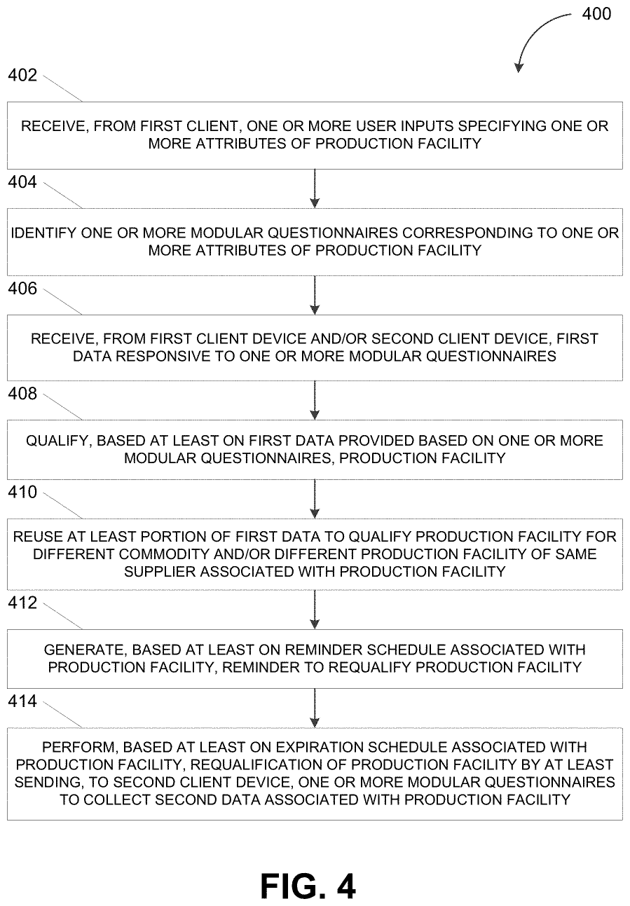

FIG. 4 depicts a flowchart illustrating an example of a process 400 for a customized lifecycle management process for production facility qualification, in accordance with some example embodiments. Referring to FIGS. 1-4, the process 400 may be performed by the lifecycle management controller 110 in order to generate and qualify a custom lifecycle management process to qualify a production facility.

At 402, the lifecycle management controller 110 may receive, from a first client device one or more user inputs specifying one or more attributes of a production facility. For example, the lifecycle management controller 110 may receive, via the electronic intake form 200 displayed in the user interface 135 at the first client device 130a, one or more user inputs specifying a type of production facility (e.g., direct, indirect, warehouse, and/or the like), a commodity associated the production facility, a region associated with the production facility, and/or a department associated with the production facility.

At 404, the lifecycle management controller 110 may identify one or more modular questionnaires corresponding to the one or more attributes of the production facility. In some example embodiments, the lifecycle management controller 110 may select, based at least on the one or more user inputs received via the electronic intake form 200, the modular questionnaire 125 from the repository 120. The modular questionnaire 125 may be selected based on the type of production facility (e.g., direct, indirect, warehouse, and/or the like), the commodity associated the production facility, the region associated with the production facility, and/or the department associated with the production facility. Moreover, the modular questionnaire 125 may be configured to collect data associated with the production facility. In the event the lifecycle management controller 110 is unable to identify a modular questionnaire matching the one or more use inputs received from the first client device 130a, the lifecycle management controller 110 may generate, for display in the user interface 135 at the first client device 130a, an error message.

At 406, the lifecycle management controller 110 may receive, from the first client device or a second client device, a first data responsive to the one or more modular questionnaires. For example, in some example embodiments, the lifecycle management controller 110 may send the modular questionnaire 125 to the second client device 130b, which may be associated with the production facility and/or the supplier associated with the production facility. As such, the lifecycle management controller 110 may receive, from the second client device 130b, data provided based at least on the modular questionnaire 125. In instances where the modular questionnaire 125 is an electronic form, at least a portion of the modular questionnaire 125 may be displayed in the user interface 135 at the second client device 130b and the data associated with the production facility may be provided as one or more user inputs received via the modular questionnaire 125 displayed in the user interface 135. Alternatively, in some cases, the modular questionnaire 125 may displayed in the user interface 135 at the first client device 130a such that the data associated with the production facility may be provided as one or more user inputs received at the first client device 130a.

At 408, the lifecycle management controller 110 may qualify, based at least on the first data provided based on the one or more modular questionnaires, the production facility. For example, the lifecycle management controller 110 may qualify, based at least on the data provided based on the modular questionnaire 125, the production facility. The qualification of the production facility may be performed with (or without) user inputs received via the first client device 130a. For instance, in some cases, the lifecycle management controller 110 may qualify the production facility in response to receiving, from the first client device 130a, one or more user inputs approving the data collected via the modular questionnaire 125.

At 410, the lifecycle management controller 110 may reuse at least a portion of the first data to qualify the same production facility for a different matrix dimension (e.g., commodity, region, department and/or the like) and/or a different production facility of the same supplier. For example, the lifecycle management controller 110 may reuse the data provided based on the modular questionnaire 125 in order to qualify the same production facility for a different matrix dimension (e.g., commodity, region, department, and/or the like) and/or a different production facility of the same supplier. The lifecycle management controller 110 may reuse the data collected via the modular questionnaire 125 while the data remains unexpired, for example, as based on an expiration schedule specified as a part of configuring the custom lifecycle management process including the modular questionnaire 125.

At 412, the lifecycle management controller 110 may generate, based at least on a reminder schedule associated with the production facility, a reminder to requalify the production facility. In some example embodiments, the production facility may be associated with a reminder schedule, which may be configured as a part of generating the custom lifecycle management process to qualify the production facility. As such, the data collected via the modular questionnaire 125 included in the custom lifecycle management process may be subjected to an expiration schedule (e.g., a date and/or an event triggering the expiration of the data). The reminder schedule may be configured to trigger one or more reminders in accordance with a specified time and/or frequency ahead of the expiration of the data collected via the modular questionnaire 125.

At 414, the lifecycle management controller 110 may perform, based at least on an expiration schedule associated with the production facility, a requalification of the production facility by at least sending, to the second client device, the one or more modular questionnaires to collect a second data associated with the production facility. For example, while the data collected via the modular questionnaire 125 remains unexpired, the lifecycle management controller 110 may continue to reuse at least a portion of the data to qualify the same production facility for a different matrix dimension (e.g., commodity, region, department, and/or the like) and/or a different production facility of the same supplier. However, upon expiration of the data collected via the modular questionnaire 125, the lifecycle management controller 110 may requalify the production facility by at least deploying the modular questionnaire 125 to collect additional data associated with the production facility.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system, comprising: at least one data processor; and at least one memory storing instructions, which when executed by the at least one data processor, result in operations comprising: receiving, from a first client device, a first user input specifying one or more attributes of a first production facility; identifying a first modular questionnaire corresponding to the one or more attributes of the first production facility; receiving, at the first client device and/or a second client device, a second user input responsive to the first modular questionnaire, the second user input including a first data associated with the first production facility; and qualifying, based on at least a portion of the first data, the first production facility.

Example 2: The system of example 1, wherein the first user input further defines an expiration schedule associated with the first production facility.

Example 3: The system of example 2, wherein the operations further comprise: reusing, while the first data remains unexpired based on the expiration schedule, at least a portion of the first data to qualify the first production for a different matrix dimension and/or a second production facility associated with a same supplier, the different matrix dimension comprising one or more of a different commodity, a different region, a different department, or a custom process type.

Example 4: The system of any one of examples 2 to 3, wherein the operations further comprise: determining, based at least on the expiration schedule, an expiration of the first data associated with the first production facility; and in response to determining the expiration of the first data, requalifying the first production facility by at least a third user input received from the first client device and/or the second client device, the third user input comprising a second data responsive to the first modular questionnaire.

Example 5: The system of any one of examples 1 to 4, wherein the first user input further defines a reminder schedule associated with the first production facility.

Example 6: The system of any one of examples 1 to 5, wherein the operations further comprise: generating, based at least on a time and/or a frequency specified by the reminder schedule, a reminder to requalify the first production facility.

Example 7: The system of any one of examples 1 to 6, wherein the operations further comprise: identifying a second modular questionnaire corresponding to the one or more attributes of the first production facility; and receiving, from the first client device and/or the second client device, a third user input responsive to the second modular questionnaire, the third user input including a second data associated with the first production facility.

Example 8: The system of example 7, wherein the operations further comprise: in response to a failure to qualify the first production facility based on the first data collected via the first modular questionnaire and/or the second data collected via the second modular questionnaire, qualifying the first production facility based on a fourth user input received from the first client device and/or the second client device.

Example 9: The system of any one of examples 1 to 8, wherein the operations further comprise: in response to failing to identify a modular questionnaire corresponding to the one or more attributes of the first production facility, generating an error message for display at the first client device and/or the second client device.

Example 10: The system of any one of examples 1 to 9, wherein the first modular questionnaire comprises a mandatory questionnaire or an optional questionnaire.

Example 11: The system of any one of examples 1 to 10, wherein the first modular questionnaire comprises an electronic form that is displayed at the first client device and/or the second client device.

Example 12: The system of any one of examples 1 to 11, wherein the qualification of the first production facility is performed via an application programming interface (API).

Example 13: The system of any one of examples 1 to 12, wherein the first data and/or an outcome of the qualification are shared with a third party system in an extensible markup language (XML) format.

Example 14: A computer-implemented method, comprising: receiving, from a first client device, a first user input specifying one or more attributes of a first production facility; identifying a first modular questionnaire corresponding to the one or more attributes of the first production facility; receiving, at the first client device and/or a second client device, a second user input responsive to the first modular questionnaire, the second user input including a first data associated with the first production facility; and qualifying, based on at least a portion of the first data, the first production facility.

Example 15: The method of example 14, wherein the first user input further defines an expiration schedule associated with the first production facility, wherein while the first data remains unexpired based on the expiration schedule, at least a portion of the first data is reused to qualify the first production for a different matrix dimension and/or a second production facility associated with a same supplier, and wherein the different matrix dimension comprises one or more of a different commodity, a different region, a different department, or a custom process type.

Example 16: The method of any one of examples 14 to 15, further comprising: identifying a second modular questionnaire corresponding to the one or more attributes of the first production facility; and receiving, from the first client device and/or the second client device, a third user input responsive to the second modular questionnaire, the third user input including a second data associated with the first production facility.

Example 17: The method of example 16, further comprising: in response to a failure to qualify the first production facility based on the first data collected via the first modular questionnaire and/or the second data collected via the second modular questionnaire, qualifying the first production facility based on a fourth user input received from the first client device and/or the second client device.

Example 18: The method of any one of examples 14 to 17, wherein the first modular questionnaire comprises a mandatory questionnaire or an optional questionnaire.

Example 19: The method of any one of examples 14 to 18, wherein the first modular questionnaire comprises an electronic form that is displayed at the first client device and/or the second client device.

Example 20: A non-transitory computer readable medium storing instructions, which when executed by at least one data processor, result in operations comprising: receiving, from a first client device, a first user input specifying one or more attributes of a first production facility; identifying a first modular questionnaire corresponding to the one or more attributes of the first production facility; receiving, at the first client device and/or a second client device, a second user input responsive to the first modular questionnaire, the second user input including a first data associated with the first production facility; and qualifying, based on at least a portion of the first data, the first production facility.

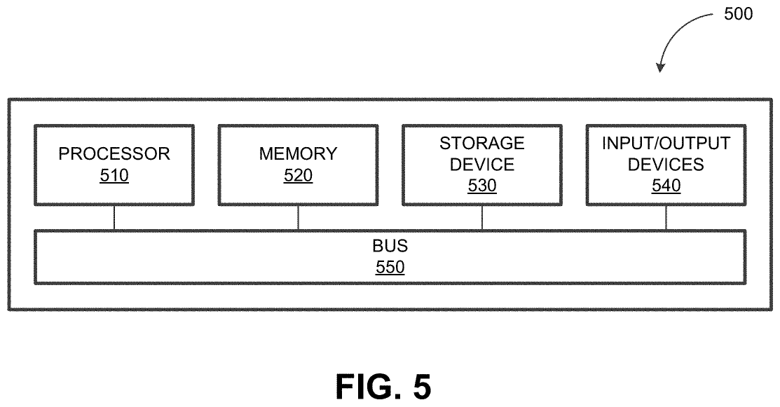

FIG. 5 depicts a block diagram illustrating a computing system 500, in accordance with some example embodiments. Referring to FIGS. 1-5, the computing system 500 can be used to implement the lifecycle management controller 110 and/or any components therein.

As shown in FIG. 5, the computing system 500 can include a processor 510, a memory 520, a storage device 530, and an input/output device 540. The processor 510, the memory 520, the storage device 530, and the input/output device 540 can be interconnected via a system bus 550. The processor 510 is capable of processing instructions for execution within the computing system 500. Such executed instructions can implement one or more components of, for example, the lifecycle management controller 110. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 500 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A system, comprising:
at least one processor; and
at least one memory including program code which when executed by the at least one processor provides operations comprising:
receiving, from a first client device, a first user input specifying one or more attributes of a first production facility;
identifying a first modular questionnaire corresponding to the one or more attributes of the first production facility;
receiving, at the first client device and/or a second client device, a second user input responsive to the first modular questionnaire, the second user input including a first data associated with the first production facility; and
qualifying, based on at least a portion of the first data, the first production facility.

2. The system of claim 1, wherein the first user input further defines an expiration schedule associated with the first production facility.

3. The system of claim 2, wherein the operations further comprise:
reusing, while the first data remains unexpired based on the expiration schedule, at least a portion of the first data to qualify the first production for a different matrix dimension and/or a second production facility associated with a same supplier, the different matrix dimension comprising one or more of a different commodity, a different region, a different department, or a custom process type.

4. The system of claim 2, wherein the operations further comprise:
determining, based at least on the expiration schedule, an expiration of the first data associated with the first production facility; and
in response to determining the expiration of the first data, requalifying the first production facility by at least a third user input received from the first client device and/or the second client device, the third user input comprising a second data responsive to the first modular questionnaire.

5. The system of claim 1, wherein the first user input further defines a reminder schedule associated with the first production facility.

6. The system of claim 1, wherein the operations further comprise:
generating, based at least on a time and/or a frequency specified by the reminder schedule, a reminder to requalify the first production facility.

7. The system of claim 1, wherein the operations further comprise:
identifying a second modular questionnaire corresponding to the one or more attributes of the first production facility; and
receiving, from the first client device and/or the second client device, a third user input responsive to the second modular questionnaire, the third user input including a second data associated with the first production facility.

8. The system of claim 7, wherein the operations further comprise:
in response to a failure to qualify the first production facility based on the first data collected via the first modular questionnaire and/or the second data collected via the second modular questionnaire, qualifying the first production facility based on a fourth user input received from the first client device and/or the second client device.

9. The system of claim 1, wherein the operations further comprise:
in response to failing to identify a modular questionnaire corresponding to the one or more attributes of the first production facility, generating an error message for display at the first client device and/or the second client device.

10. The system of claim 1, wherein the first modular questionnaire comprises a mandatory questionnaire or an optional questionnaire.

11. The system of claim 1, wherein the first modular questionnaire comprises an electronic form that is displayed at the first client device and/or the second client device.

12. The system of claim 1, wherein the qualification of the first production facility is performed via an application programming interface (API).

13. The system of claim 1, wherein the first data and/or an outcome of the qualification are shared with a third party system in an extensible markup language (XML) format.

14. A computer-implemented method, comprising:
receiving, from a first client device, a first user input specifying one or more attributes of a first production facility;
identifying a first modular questionnaire corresponding to the one or more attributes of the first production facility;
receiving, at the first client device and/or a second client device, a second user input responsive to the first modular questionnaire, the second user input including a first data associated with the first production facility; and
qualifying, based on at least a portion of the first data, the first production facility.

15. The method of claim 14, wherein the first user input further defines an expiration schedule associated with the first production facility, wherein while the first data remains unexpired based on the expiration schedule, at least a portion of the first data is reused to qualify the first production for a different matrix dimension and/or a second production facility associated with a same supplier, and wherein the different matrix dimension comprises one or more of a different commodity, a different region, a different department, or a custom process type.

16. The method of claim 14, further comprising:
identifying a second modular questionnaire corresponding to the one or more attributes of the first production facility; and
receiving, from the first client device and/or the second client device, a third user input responsive to the second modular questionnaire, the third user input including a second data associated with the first production facility.

17. The method of claim 16, further comprising:
in response to a failure to qualify the first production facility based on the first data collected via the first modular questionnaire and/or the second data collected via the second modular questionnaire, qualifying the first production facility based on a fourth user input received from the first client device and/or the second client device.

18. The method of claim 14, wherein the first modular questionnaire comprises a mandatory questionnaire or an optional questionnaire.

19. The method of claim 14, wherein the first modular questionnaire comprises an electronic form that is displayed at the first client device and/or the second client device.

20. A non-transitory computer readable medium storing instructions, which when executed by at least one data processor, result in operations comprising:
receiving, from a first client device, a first user input specifying one or more attributes of a first production facility;
identifying a first modular questionnaire corresponding to the one or more attributes of the first production facility;
receiving, at the first client device and/or a second client device, a second user input responsive to the first modular questionnaire, the second user input including a first data associated with the first production facility; and
qualifying, based on at least a portion of the first data, the first production facility.
